(19) United States
(12) Patent Application Publication
(10) Pub. No.: US 2017/0093136 A1
(43) Pub. Date: Mar. 30, 2017

(54) MULTI-MODE CIRCUIT BREAKER POD

(71) Applicant: MITSUBISHI ELECTRIC POWER PRODUCTS, INC., Warrendale, PA (US)

(72) Inventors: Nathan R. Riemer, Grove City, PA (US); Jordan J. Liebert, Seven Fields, PA (US); Matthew A. Balmer, Beaver Falls, PA (US)

(21) Appl. No.: 14/871,737

(22) Filed: Sep. 30, 2015

(51) Int. Cl. H02B 1/04

(52) U.S. Cl. CPC H02B 1/04

(57) ABSTRACT

A multi-mode circuit breaker pod having multiple electrically isolated sections mounted to a common frame. Each of the multiple electrically isolated sections is operable independent of the other sections, includes one or more circuit breakers, is couplable to one or more loads and one or more sources, and is configurable to operate in individual ones of a plurality of operating modes including a parallel system summing mode, a power distribution mode, and a redundant power distribution mode. The electrically isolated sections of the multi-mode circuit breaker pod can be interconnected to operate jointly in individual ones of a plurality of operating modes including a parallel system summing mode, a power distribution mode, and a redundant power distribution mode.

### FIELD

The embodiments described herein relate generally to power distribution and control and, more particularly, to a circuit breaker pod having multiple operating modes.

### BACKGROUND INFORMATION

A circuit breaker is an automatically operated electrical switch designed to protect an electrical circuit from damage caused by overload or short circuit. Its basic function is to detect a fault condition and interrupt current flow. Unlike a fuse, which operates once and then must be replaced, a circuit breaker can be reset (either manually or automatically) to resume normal operation. Circuit breakers are made in varying sizes, from small devices that protect an individual household appliance up to large switchgear designed to protect high voltage circuits feeding an entire city.

Uninterruptible power supplies (UPSs) are electrical devices that are positioned between a power distribution system and sensitive loads. They supply power that is much more reliable than the distribution system and corresponds to the needs of sensitive loads in terms of quality and availability.

A UPS typically receives power from two or more sources simultaneously. It is usually powered directly from a main source, while simultaneously charging a storage battery. Should there be a dropout or failure of the mains, the battery instantly takes over so that the load never experiences an interruption. Other redundant power sources include secondary feeders or generators.

In view of the foregoing, it is therefore desirable to provide a circuit breaker pod having multiple operating modes.

### SUMMARY

The present disclosure is directed to a multi-mode circuit breaker pod having multiple operating modes. According to certain embodiments, a multi-mode circuit breaker pod comprises multiple electrically isolated sections mounted to a common frame. Each of the multiple electrically isolated sections is operable independent of the other sections, includes one or more circuit breakers, is couplable to one or more loads and one or more sources, and is configurable to operate in individual ones of a plurality of operating modes including a parallel system summing mode, a power distribution mode, and a redundant power distribution mode. The electrically isolated sections of the multi-mode circuit breaker pod can be interconnected to operate jointly in individual ones of a plurality of operating modes including a parallel system summing mode, a power distribution mode, and a redundant power distribution mode.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 illustrates an exemplary multi-mode circuit breaker pod, according to certain embodiments.

FIG. 2A illustrates a power distribution operating mode of a first section of an exemplary multi-mode circuit breaker pod, according to certain embodiments.

FIG. 2B illustrates a parallel summing operating mode of a first section of an exemplary multi-mode circuit breaker pod, according to certain embodiments.

FIG. 2C illustrates a redundant power distribution operating mode of a first section of an exemplary multi-mode circuit breaker pod, according to certain embodiments.

FIG. 3A illustrates a power distribution operating mode of a second section of an exemplary multi-mode circuit breaker pod, according to certain embodiments.

FIG. 3B illustrates a parallel summing operating mode of a second section of an exemplary multi-mode circuit breaker pod, according to certain embodiments.

FIG. 3C illustrates a redundant power distribution operating mode of a second section of an exemplary multi-mode circuit breaker pod, according to certain embodiments.

FIG. 4A illustrates an interconnected power distribution operating mode of an exemplary multi-mode circuit breaker pod, according to certain embodiments.

FIG. 4B illustrates an interconnected parallel summing operating mode of an exemplary multi-mode circuit breaker pod, according to certain embodiments.

FIG. 4C illustrates an interconnected redundant power distribution operating mode of an exemplary multi-mode circuit breaker pod, according to certain embodiments.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce a multi-mode circuit breaker pod having multiple operating modes. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

Conventional circuit breakers typically have a single operating mode. The embodiments described herein provide a novel technique that allows for a single circuit breaker pod to operate in multiple modes. The multi-mode circuit breaker pod described herein is autonomous and can be installed in various types of switchboards or other electrical enclosures.

The embodiments described herein are directed to a circuit breaker pod having at least three operating modes, including power distribution, parallel summing, and redundant power distribution. Power distribution refers to providing power from a source to a load (or electricity utilizing equipment). Power distribution systems preferably include short circuit protection and overcurrent protection for the connected loads. Parallel summing refers to parallel summing of separate in-phase electrical sources, which increases a system's electrical capacity. Redundant power distribution refers to providing selection of an alternate electrical source to supply a load or loads in the event that supply from a main electrical source is interrupted.

According to certain embodiments, a multi-mode circuit breaker pod comprises multiple electrically isolated sections mounted to a common frame. Each of the multiple electrically isolated sections is operable independent of the other sections, includes one or more circuit breakers, is couplable to one or more loads and one or more sources, and is configurable to operate in individual ones of a plurality of operating modes including a parallel system summing mode, a power distribution mode, and a redundant power distribution mode. The electrically isolated sections of the multi-mode circuit breaker pod can be interconnected to operate jointly in individual ones of a plurality of operating modes including a parallel system summing mode, a power distribution mode, and a redundant power distribution mode.

An interlock may be employed to ensure safe transfer from a main power source to an alternate power source. The interlock can include one or more devices—electrical, mechanical, or electro-mechanical—that prevent both the main power source and the alternate power source from powering the load(s) simultaneously. If such simultaneous powering were to happen, an overload condition may occur, or a back-feed of alternative power onto the main source may occur and cause dangerous voltage far down the main source line. An interlock device is designed to allow an alternate power source to provide power in such a way that it prevents the main power source and the alternate power source from being connected at the same time, and allows circuit breakers to operate normally without interference in the event of any overload condition.

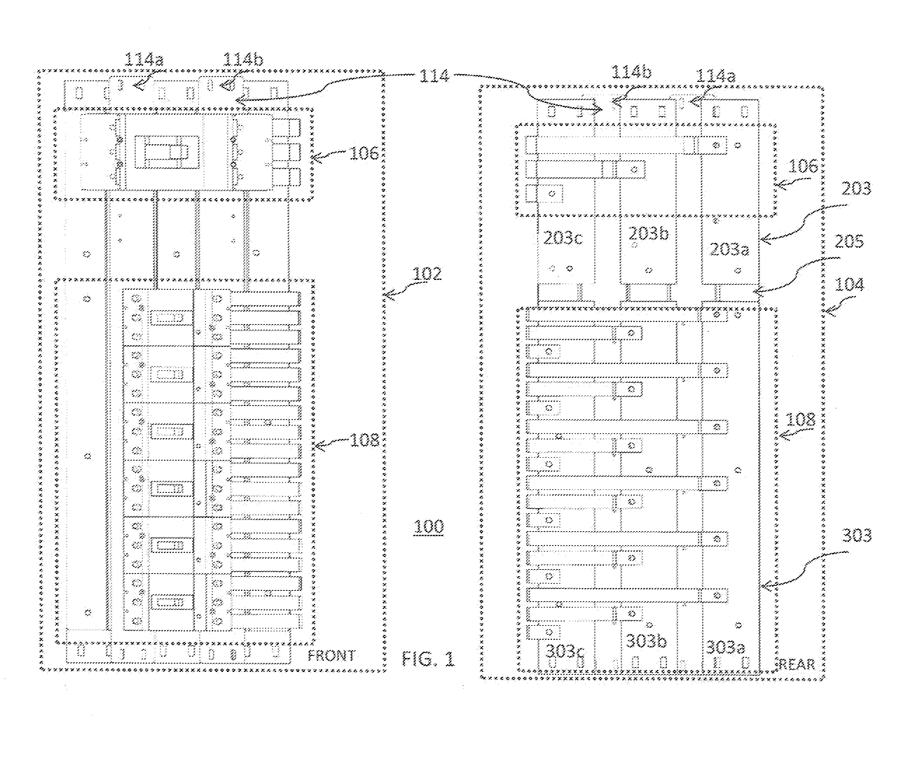

FIG. 1 illustrates an exemplary multi-mode circuit breaker pod, according to certain embodiments. A multi-mode circuit breaker pod 100 has at least two sides, referred to herein as a front 102 and a rear 104. It will be appreciated that referring herein to the sides as front 102 and rear 104 does not imply a required orientation. The multi-mode circuit breaker pod 100 includes a first section 106 and a second section 108. The first and second sections 106 and 108 are mounted via insulators such as, e.g., polyballs. onto a common frame 114 having two (2) elongate mounting posts 114a and 114b longitudinally extending in the vertical direction in FIG. 1.

The first section 106 of the multi-mode circuit breaker pod 100 is electrically isolated from the second section 108, meaning the two sections can operate independently of one another. The first and second sections 106 and 108 are coupled to first and second bussworks 203 and 303, respectively, which are mounted to the common frame 114 via insulators. The first and second bussworks 203 and 303 preferably include three (3) bussbars 203a, 203b and 203c, and 303a, 303b, and 303c, respectively, longitudinally extending in the vertical direction in FIG. 1. A gap 205 between the first and second bussworks 203 and 303 electrically isolates the first and second sections 106 and 108 from one another. This also allows for connections of multiple independent sources.

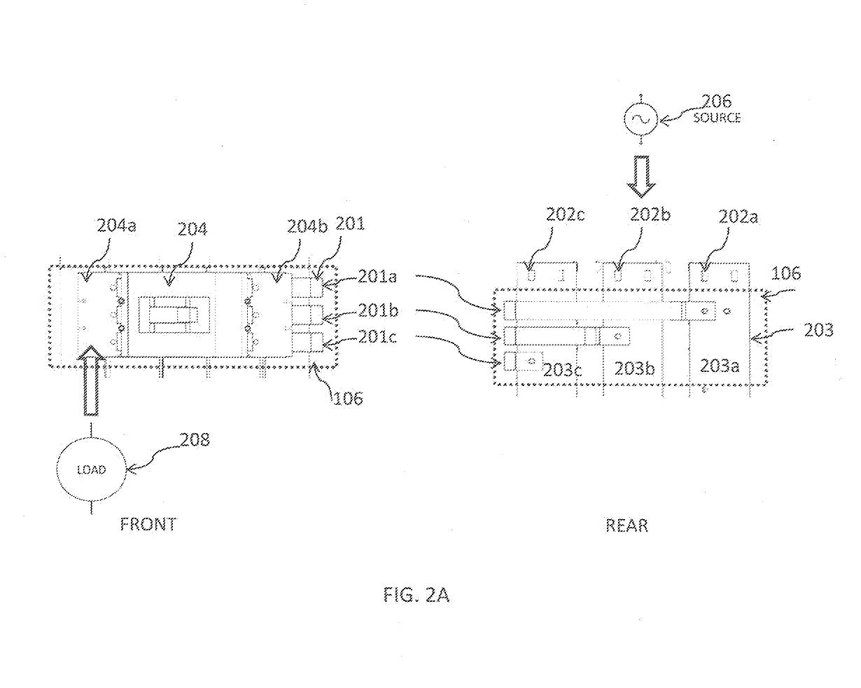

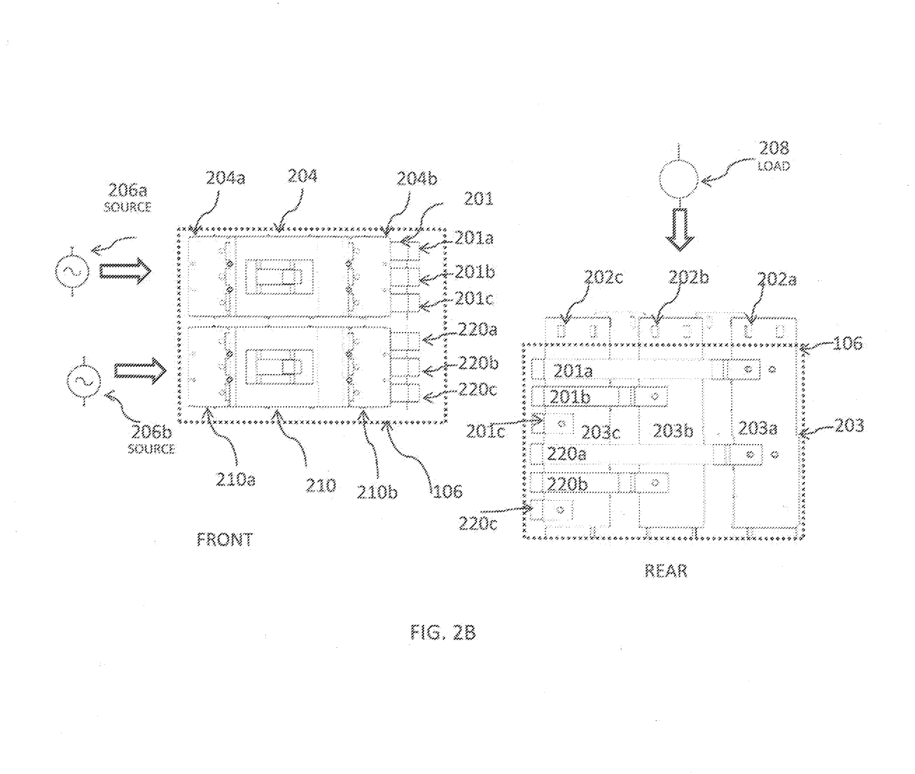

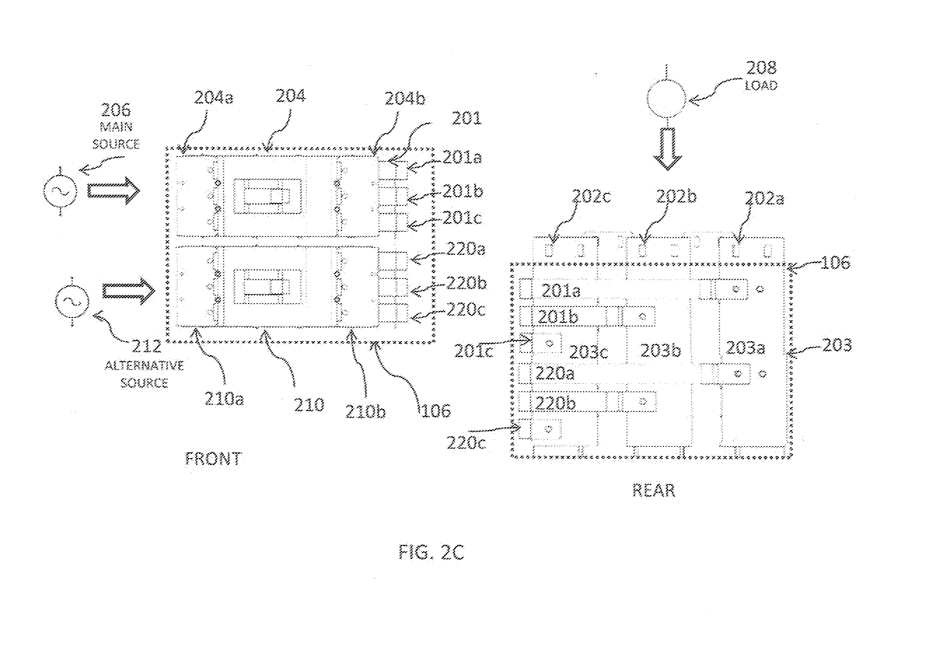

The first and second sections 106 and 108, when operating independently, each have a plurality of operating modes, preferably including at least three operating modes, they can be configured to operate in. The first and second sections 106 and 108 can be interconnected to provide the multi-mode circuit breaker pod 100 with a plurality of interconnected operating modes as well. The plurality of operating modes include a power distribution mode, a parallel summing mode, and a redundant power distribution mode. The configurations for these operating modes with the first section 106 are explained with reference to FIGS. 2A, 2B, and 2C.

In FIGS. 2A, 2B, and 2C, one end 204a of each circuit breaker 204 is used for field connections (e.g., a source 206 or a load 208) and the other or opposite end 204b of each circuit breaker 204 is connected to busswork or multilaminate busbar 201 comprising a plurality of bussbar fingers 201a, 201b, and 201c extending laterally across and connecting to individual ones of the plurality of bussbars 203a, 203b, and 203c of frame mounted busswork 203. The frame mounted busswork 203 includes connection points 202a, 202b, and 202c at an end of the bussbars 203a, 203b, and 203c for field connections (e.g., a source 206 or a load 208).

FIG. 2A illustrates a power distribution operating mode of a first section 106 of an exemplary multi-mode circuit breaker pod, according to certain embodiments. In a power distribution operating mode, a source 206 is connected to connection points 202a, 202b, and 202c on the end of each of the bussbars 203a, 203b, and 203c of the frame mounted busswork 203 of the first section 106. An electrical load 208 is connected to a circuit breaker 204 of the first section 106. This operating mode enables distribution or delivery of power from the source 206 to the load 208, as well as short circuit and overcurrent protection provided by the circuit breaker 204.

FIG. 2B illustrates a parallel summing operating mode of a first section 106 of an exemplary multi-mode circuit breaker pod, according to certain embodiments. In a parallel summing operating mode, a first source 206a is connected to one end 204a of circuit breaker 204 of the first section 106. A second source 206b is connected to one end 210a of a second circuit breaker 210 of the first section 106, while the other or opposite end 210b of the second circuit breaker 210 is connected to busswork or multilaminate busbar comprising a plurality of bussbar fingers 220a, 220b, and 220c extending laterally across and connecting to individual ones of the plurality of bussbars 203a, 203b, and 203c of frame mounted busswork 203. An electrical load 208 is connected to connection points 202a, 202b, and 202c at an end of the bussbars 203a, 203b, and 203c of the frame mounted busswork 203 of the first section 106. This operating mode enables parallel summing of the first source 206a and second source 206b, thereby increasing the system's electrical capacity.

FIG. 2C illustrates a redundant power distribution operating mode of a first section 106 of an exemplary multi-mode circuit breaker pod, according to certain embodiments. In a redundant power distribution mode, a main source 206 is connected to a first circuit breaker 204 of the first section 106. An alternative source 212 is connected to one end 210a of a second circuit breaker 210 of the first section 106, while the other or opposite end 210b of the second circuit breaker 212 is connected to busswork or multilaminate busbar comprising a plurality of bussbar fingers 220a, 220b, and 220c extending laterally across and connecting to individual ones of the plurality of bussbars 203a, 203b, and 203c of frame mounted busswork 203. An electrical load 208 is connected to connection points 202a, 202b, and 202c at an end of the bussbars 203a, 203b, and 203c of the frame mounted busswork 203 of the first section 106. This operating mode provides for use of the alternative source 212 to distribute or deliver power to load 208 when main source 206 is interrupted.

In all of the configurations described herein, circuit breakers may be interlocked using an interlocking device as desired or required.

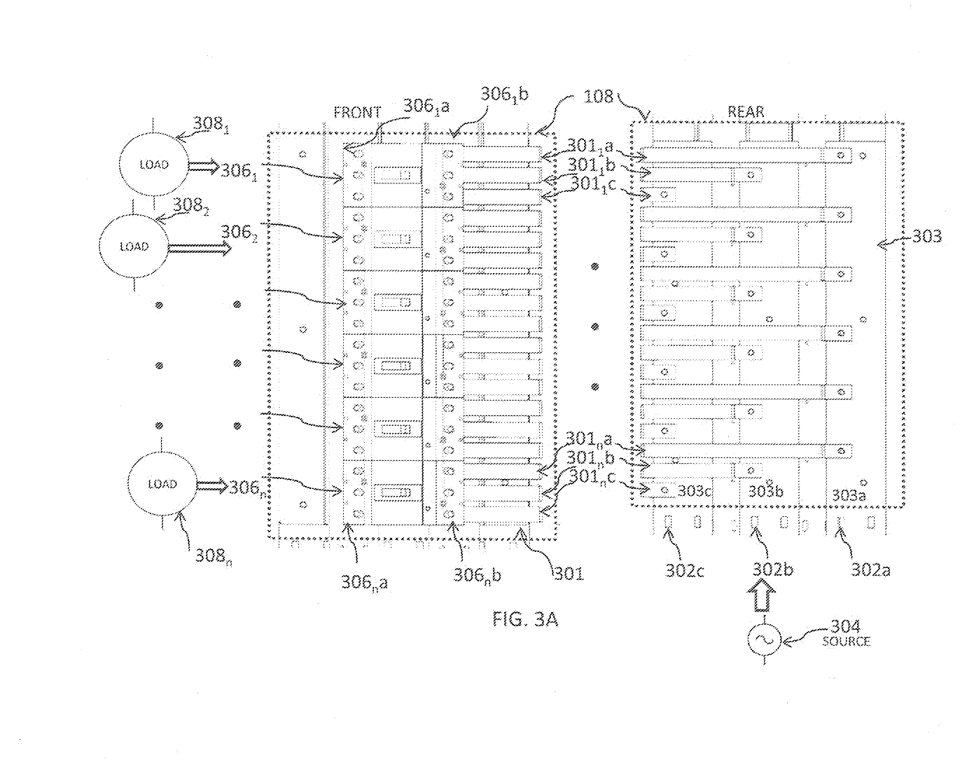

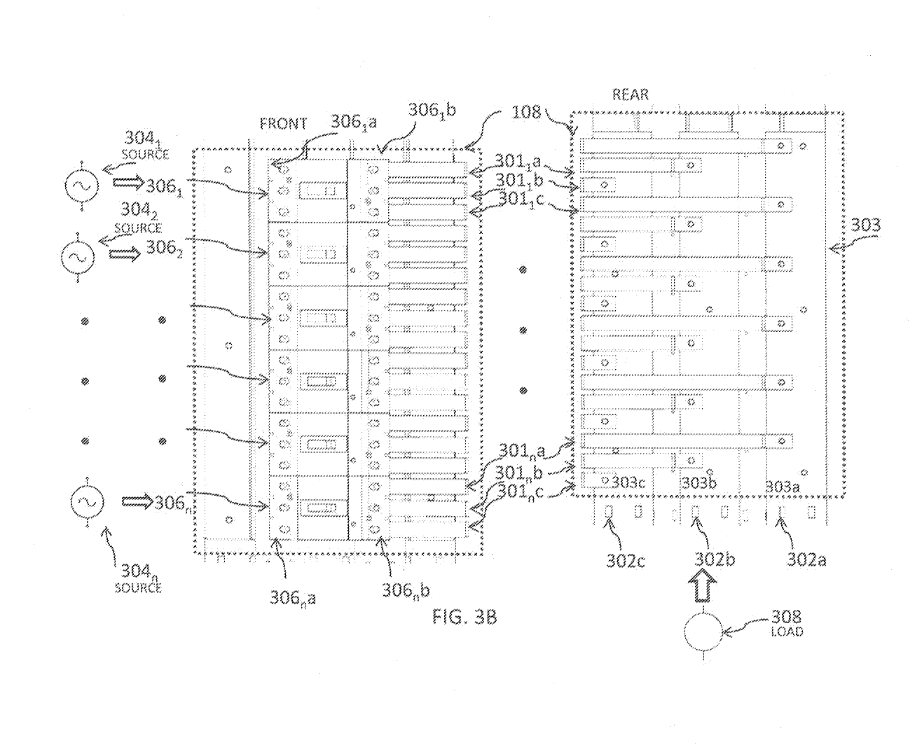

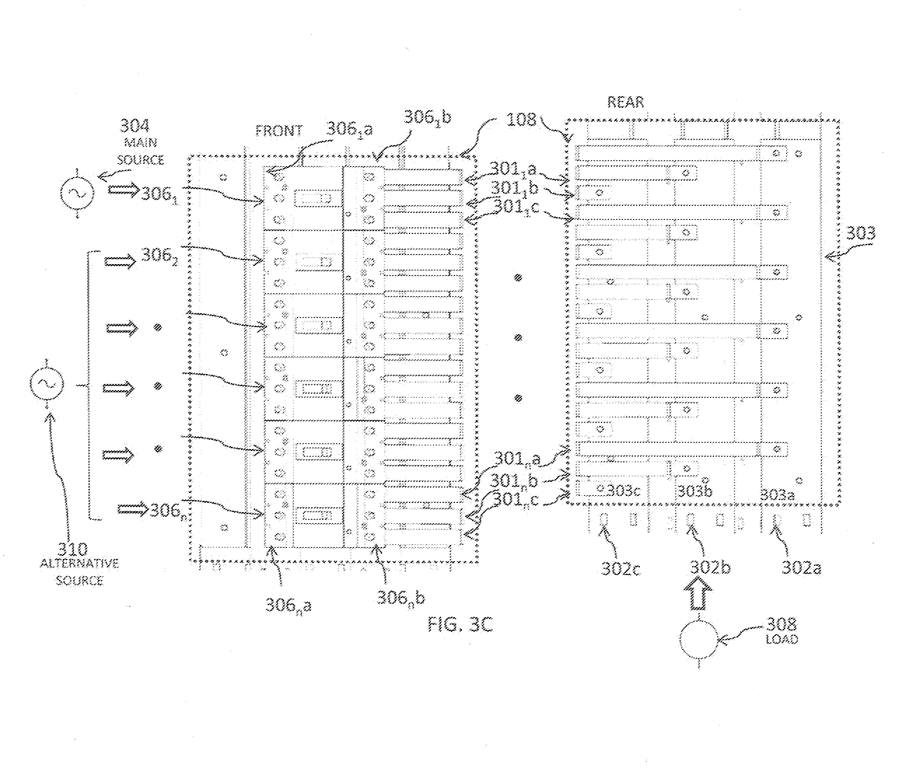

The configurations for the same operating modes with the second section 108 are explained with reference to FIGS. 3A, 3B, and 3C.

In FIGS. 3A, 3B, and 3C, one end 306₁a . . . 306ₙa of each circuit breaker 306₁, 306₂, . . . , 306ₙ described herein is used for field connections (e.g., a source 304 or a load 308) and the other or opposite end 306₁b . . . 306ₙb) of each circuit breaker 306₁, 306₂, . . . , 306ₙ is connected to busswork or multilaminate busbar 301 comprising a plurality of bussbar fingers 301a, 301b, and 301c extending laterally across and connecting to individual ones of the plurality of bussbars 303a, 303b, and 303c of the frame mounted busswork 303. The frame mounted busswork 303 includes connection points 302a, 302b, and 302c for field connections (e.g., a source 304 or a load 308).

FIG. 3A illustrates a power distribution operating mode of a second section 108 of an exemplary multi-mode circuit breaker pod, according to certain embodiments. The second section 108 comprises a plurality of circuit breakers 306₁, 306₂, . . . , 306ₙ. In a power distribution operating mode, an electrical source 304 is connected to connection points 302a, 302b, and 302c at an end of the bussbars 303a, 303b, and 303c of the frame mounted busswork 303 of the second section 108. A plurality of loads, 308₁, 308₂, . . . 308ₙ, is connected to the plurality of circuit breakers 306₁, 306₂, . . . , 306ₙ of the second section 108. This operating mode enables distribution of power from the source 304 to the plurality of loads 308₁, 308₂, . . . 308ₙ, in addition to short circuit and overcurrent protection provided by the plurality of circuit breakers 306₁, 306₂, . . . , 306ₙ.

FIG. 3B illustrates a parallel summing operating mode of a second section 108 of an exemplary multi-mode circuit breaker pod, according to certain embodiments. In a parallel summing operating mode, a plurality of sources 304₁, 304₂, . . . 304ₙ, is connected to the plurality of circuit breakers 306₁, 306₂, . . . , 306ₙ of the second section 108. An electrical load 308 is connected to connection points 302a, 302b, and 302c at an end of the bussbars 303a, 303b, and 303c of the frame mounted busswork 303 of the second section 108. This operating mode enables parallel summing of sources 304₁, 304₂, . . . 304ₙ, thereby increasing the system's electrical capacity for supplying or delivering power to load 308.

FIG. 3C illustrates a redundant power distribution operating mode of a second section 108 of an exemplary multi-mode circuit breaker pod, according to certain embodiments. In a redundant power distribution operating mode, a main source 304 is connected to a first circuit breaker 306₁. An alternate source 310 is then connected to the remaining circuit breakers 306₂ . . . 306ₙ of the plurality of circuit breakers of the second section 108. An electrical load 308 is connected to connection points 302a, 302b, and 302c at an end of the bussbars 303a, 303b, and 303c of the frame mounted busswork 303 of the second section 108. This operating mode enables distribution of power from alternate source 310 when main source 304 is interrupted.

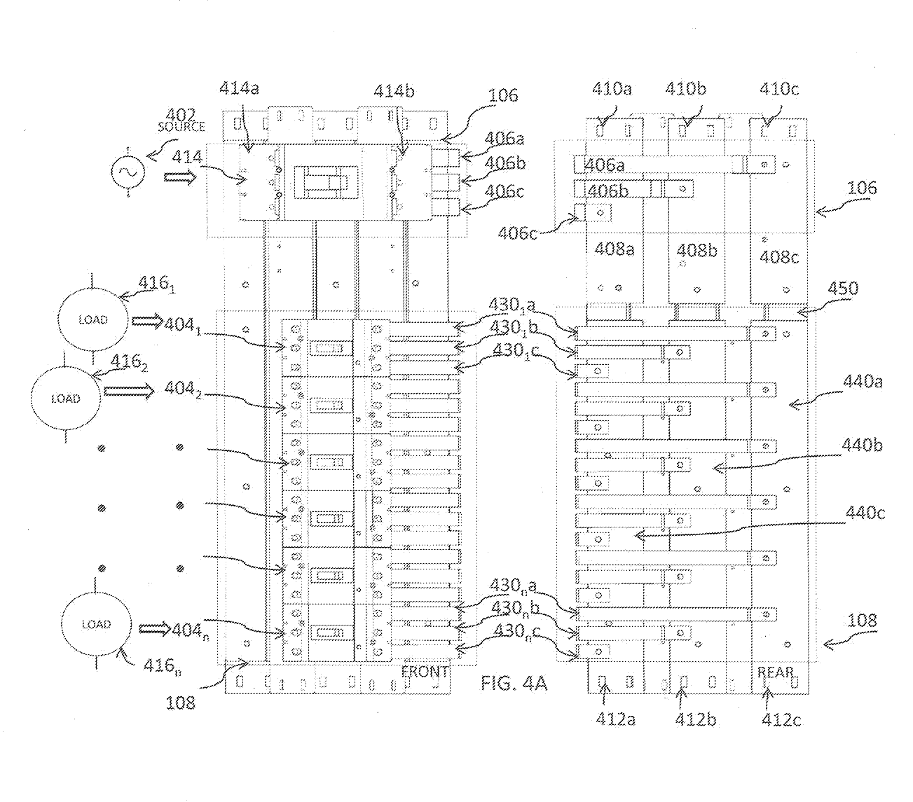

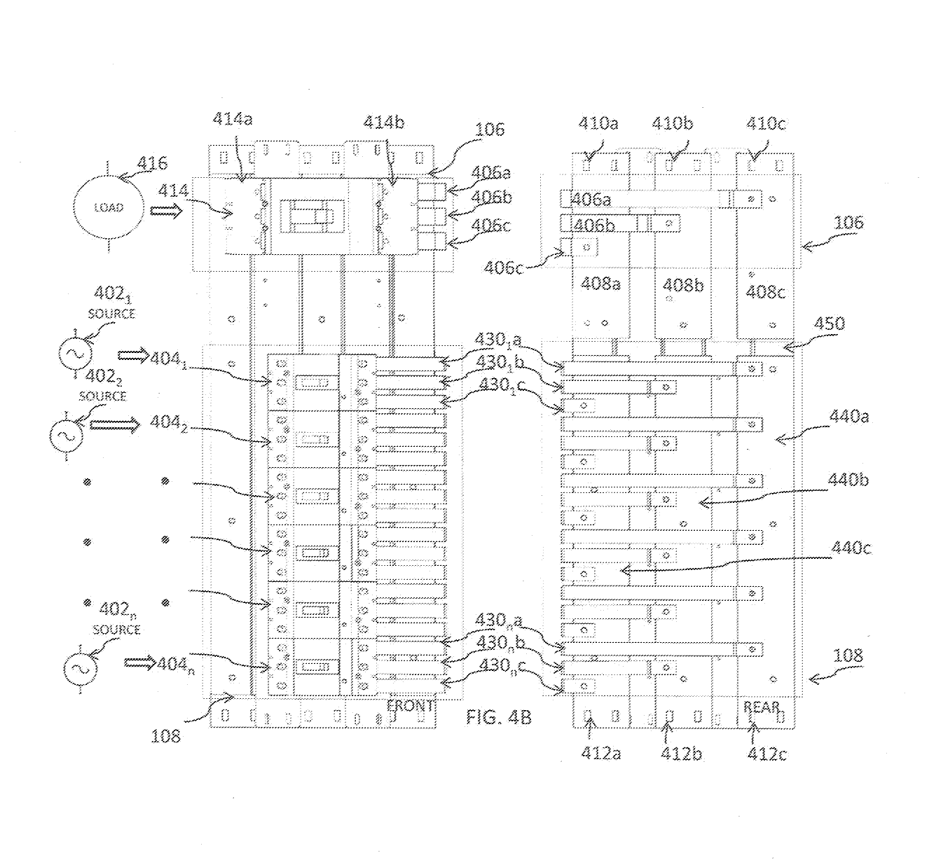

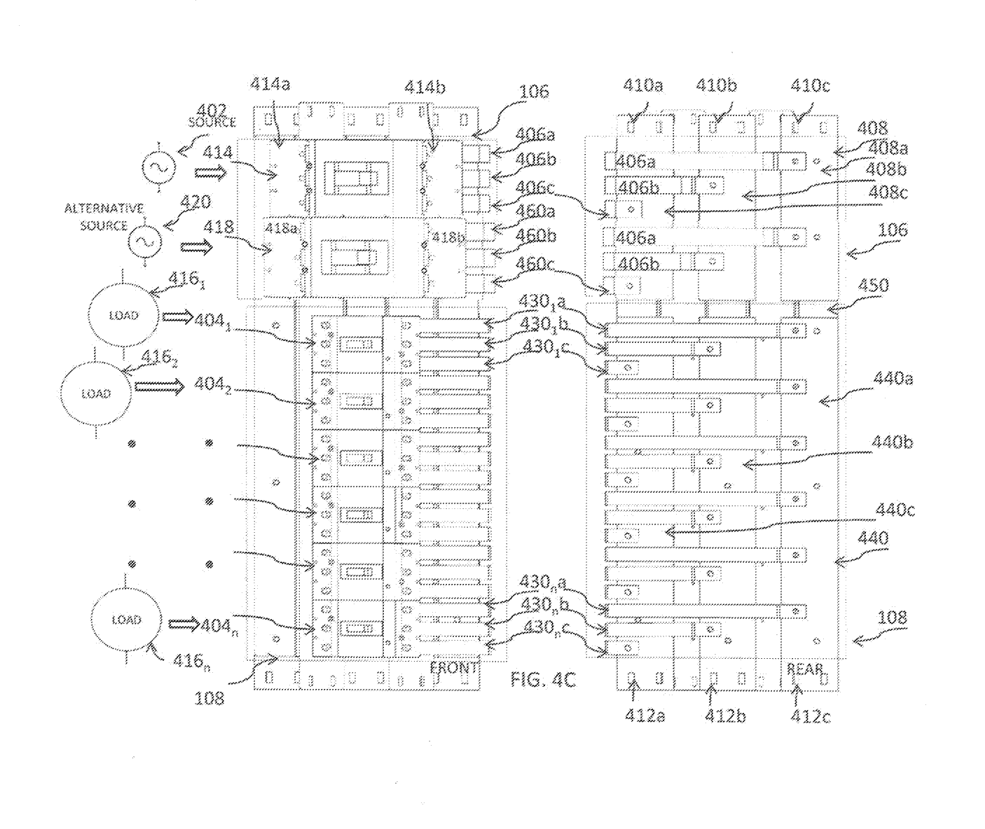

As discussed above, first section 106 and second section 108 can be interconnected to enable the entire system to have three operating modes. The configurations for interconnected operating modes are explained with reference to FIGS. 4A, 4B, and 4C.

In FIGS. 4A, 4B, and 4C, the first section 106 of the multi-mode circuit breaker pod is electrically isolated from the second section 108, meaning the two sections can operate independently of one another. The first and second sections 106 and 108 are electrically isolated by a gap 450 between first and second bussworks 408 and 412 having three (3) bussbars 408a, 408b, 408c, 412a, 412b, and 412c, which are mounted to the frame 114 and longitudinally extending in the vertical direction in the FIGS. 4A, 4B and 4C.

One end 414a, 418a, 404₁a . . . 404ₙa of each circuit breaker 414, 418, 404₁, 404₂, . . . , 404ₙ is used for field connections (e.g., a source 402 or a load 416) and the other or opposite end 414b, 418b, 404₁b . . . 404ₙb) of each circuit breaker 414, 418, 404₁, 404₂, . . . , 404ₙ is connected to busswork or multilaminate busbar, respectively, comprising a plurality of bussbar fingers 406a, 406b, 406c, 430₁a,b,c . . . 430ₙa,b,c extending laterally across and connecting to individual ones of the bussbars 408a, 408b, 408c, 440a, 440b, and 440c of the frame mounted bussworks 408, 440. The frame mounted bussworks 408, 440 includes connection points 410a, 410b, 410c, 412a, 412b, and 412c for field connections (e.g., a source or a load) or interconnections of the first and sections 106 and 108.

FIG. 4A illustrates an interconnected power distribution operating mode of an exemplary multi-mode circuit breaker pod, according to certain embodiments. In an interconnected power distribution operating mode, a source 402 is connected to a circuit breaker 414 of the first section 106. A plurality of loads 416₁, 416₂, . . . 416ₙ is connected to a plurality of circuit breakers 404₁, 404₂, . . . , 404ₙ of the second section 108. The busswork 408 field connections 410a, 410b, and 410c of the first section 106 are then connected to the busswork 440 field connections 412a, 412b, and 412c of the second section 108. This operating mode enables distribution from source 402 to loads 416₁, 416₂, . . . 416ₙ, as well as short circuit and overcurrent protection provided by circuit breakers 414, 404₁, 404₂, . . . , 404ₙ.

FIG. 4B illustrates an interconnected parallel summing operating mode of an exemplary multi-mode circuit breaker pod, according to certain embodiments. In an interconnected parallel summing operating mode, an electrical load 416 is connected to a circuit breaker 414 of the first section 106. A plurality of sources 402₁, 402₂, . . . 402ₙ is connected to a plurality of circuit breakers 404₁, 404₂, . . . , 404ₙ of the second section 108. The busswork 408 field connections 410a, 410b, and 410c of the first section 106 are then connected to the busswork 440 field connections 412a, 412b, and 412c of the second section 108. This operating mode enables summing of sources 402₁, 402₂, . . . 402ₙ, thereby increasing the system's electrical capacity.

FIG. 4C illustrates an interconnected redundant power distribution operating mode of an exemplary multi-mode circuit breaker pod, according to certain embodiments. In an interconnected redundant power distribution operating mode, a main source 402 is connected to a first circuit breaker 414 of the first section 106. An alternative source 420 is connected to a second circuit breaker 418 of the first section 106. A plurality of loads 416₁, 416₂, . . . 416ₙ is connected to a plurality of circuit breakers 404₁, 404₂, . . . , 404ₙ of the second section 108. The busswork 408 field connections 410a, 410b, and 410c of the first section 106 are then connected to the busswork 440 field connections 412a, 412b, and 412c of the second section 108. This enables distribution or delivery from the alternative source 420 to the loads 416₁, 416₂, . . . 416ₙ if the main power source 402 is interrupted by either a planned or unplanned outage.

Various configurations consistent with the examples set forth herein are possible and contemplated for both first section 106 and second section 108, including varying number of sources, loads, circuit breakers, and the like.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A multi-mode circuit breaker pod, comprising:
a frame,
a first section mounted to the frame, the first section comprising a first busswork and one or more circuit breakers coupled to the first busswork; and
a second section mounted to the frame, the second section comprising a second busswork and a plurality of circuit breakers coupled to the second busswork, the second section being electrically isolated from the first section;
wherein the first and second sections are configurable to operate independently in individual ones of a plurality of operating modes, and wherein the first and second sections are interconnectable and configurable to operate in individual ones of a plurality of interconnected operating modes.

2. The multi-mode circuit breaker pod of claim 1, wherein each of the plurality of operating modes and the plurality of interconnected operating modes includes three or more operating modes.

3. The multi-mode circuit breaker pod of claim 1, wherein the plurality of operating modes includes a power distribution mode, a parallel summing mode, and a redundant power distribution mode.

4. The multi-mode circuit breaker pod of claim 1, wherein the plurality of interconnected operating modes includes an interconnected power distribution mode, an interconnected parallel summing mode, and an interconnected redundant power distribution mode.

5. The multi-mode circuit breaker pod of claim 3, wherein, when operating independent of the second section, the first section operates in an individual one of the power distribution mode, parallel summing mode, and redundant power distribution mode.

6. The multi-mode circuit breaker pod of claim 5, wherein, when operating independent of the first section, the second section operates in an individual one of the power distribution mode, parallel summing mode, and redundant power distribution mode.

7. The multi-mode circuit breaker pod of claim 4, wherein, when operating in the interconnected power distribution mode,
the one or more circuit breakers of the first section are couplable to an electrical source;
the plurality of circuit breakers of the second section are couplable to a plurality of electrical loads; and
field connections of the first busswork of the first section are connected to field connections of the second busswork of the second section.

8. The multi-mode circuit breaker pod of claim 4, wherein, when operating in the interconnected parallel summing mode occurs,
the one or more circuit breakers of the first section are couplable to an electrical load;
the plurality of circuit breakers of the second section are couplable to a plurality of electrical sources; and
field connections of the first busswork of the first section are connected to field connections of the second busswork of the second section.

9. The multi-mode circuit breaker pod of claim 4, wherein, when operating in the interconnected redundant power distribution mode,
a first one of the one or more circuit breakers of the first section is couplable to a main electrical source;
a second one of the one or more circuit breakers of the first section is couplable to an alternative electrical source;
the plurality of circuit breakers of the second section is couplable a plurality of electrical loads; and
field connections of the first busswork of the first section are connected to field connections of the second busswork of the second section.

10. The multi-mode circuit breaker pod of claim 9, further comprising an interlock to prevent the main electrical source and alternative electrical source from providing power simultaneously.

11. A method of operating a multi-mode circuit breaker pod, the multi-mode circuit breaker pod comprising a first section electrically isolated from a second section, wherein the first and second sections are configurable to operate independently in individual ones of a plurality of operating modes, and wherein the first and second sections are interconnectable and configurable to operate in individual ones of a plurality of interconnected operating modes; the method comprising:
connecting field connections of a first busswork of the first section to second field connections of a second busswork of the second section;
connecting one of an electrical source and an electrical load to a circuit breaker of the first section;
when an electrical source is connected to the circuit breaker of the first section, connecting a plurality of loads to a plurality of circuit breakers of the second section; and
when an electrical load is connected to the circuit breaker of the first section, connecting a plurality of sources to the plurality of circuit breakers of the second section.

12. The method of claim 11, wherein the plurality of operating modes and plurality of interconnected operating modes each include a power distribution mode, a parallel summing mode, and a redundant power distribution mode.

13. The method of claim 11, wherein when an electrical source is connected to the circuit breaker of the first section, further comprising connecting a second electrical source to a second circuit breaker of the first section.

14. A method of operating a multi-mode circuit breaker pod, the multi-mode circuit breaker pod comprising a first section electrically isolated from a second section, wherein the first and second sections are configurable to operate independently in individual ones of a plurality of operating modes, and wherein the first and second sections are interconnectable and configurable to operate in individual ones of a plurality of interconnected operating modes; the method comprising:
connecting one of one or more electrical sources and an electrical load to one or more circuit breakers of the first section;
when two or more electrical sources of the one or more electrical sources are connected to two or more circuit breakers of the one or more circuit breakers of the first section, connecting an electrical load to field connections of a first busswork of the first section.

15. The method of claim 14, wherein the plurality of operating modes and plurality of interconnected operating modes each include a power distribution mode, a parallel summing mode, and a redundant power distribution mode.

16. The method of claim 14 further comprising
connecting one of a plurality of electrical sources and a plurality of electrical loads to a plurality of circuit breakers of the second section;
when the plurality of electrical loads is connected to the plurality of circuit breakers of the second section, connecting an electrical source to field connections of a second busswork of the second section; and
when the plurality of electrical sources is connected to the plurality of circuit breakers of the second section, connecting an electrical load to field connections of the second busswork of the second section.

17. The method of claim 16, wherein when the plurality of electrical sources is connected to the plurality of circuit breakers of the second section, the plurality of electrical sources including a main source coupled to one of the plurality of circuit breakers and an alternative source coupled to the other of the plurality of circuit breakers.

18. The method of claim 16, further comprising:
connecting field connections of a first busswork of the first section to second field connections of a second busswork of the second section;
when an electrical source is connected to the circuit breaker of the first section, connecting a plurality of loads to a plurality of circuit breakers of the second section;
when an electrical load is connected to the circuit breaker of the first section, connecting a plurality of sources to the plurality of circuit breakers of the second section; and
when two or more electrical sources of the one or more electrical sources are connected to two or more circuit breakers of the one or more circuit breakers of the first section, a plurality of loads to a plurality of circuit breakers of the second section.
